(19) United States
(12) Patent Application Publication
(10) Pub. No.: US 2007/0296488 A1
(43) Pub. Date: Dec. 27, 2007

(54) Semiconductor integrated circuits

(75) Inventor: Nam-Jong Kim, Yongin-si (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 11/812,690

(22) Filed: Jun. 21, 2007

(30) Foreign Application Priority Data
Jun. 21, 2006 (KR) 10-2006-0056079

(51) Int. Cl. G05F 1/10

(52) U.S. Cl. 327/544

(57) ABSTRACT

A semiconductor integrated circuit includes a logic circuit, a first and second switching device and an equalizer. The logic circuit includes a first circuit connected between a power supply voltage and a ground voltage supply line, and a second circuit connected between a power supply voltage supply line and a ground voltage. The first and second switching devices are connected between the power supply voltage and the power supply voltage supply line and between the ground voltage and the ground voltage supply line, respectively. The equalizer is connected between the power supply voltage supply line and the ground voltage supply line, and configured to adjust voltages of the power supply voltage supply line and the ground voltage supply line to be the same during a standby operation.

### PRIORITY STATEMENT

This non-provisional patent application claims priority under 35 U.S.C. § 119 to Korean Patent Application No. 2006-0056079, filed Jun. 21, 2006, the entire contents of which are hereby incorporated herein by reference.

### BACKGROUND

### Description of Related Art

Portable devices may be driven for the most part by battery power, and thus, relatively different from general electronic devices. For at least this reason, power consumption may be relatively important. For larger scale integrated circuit (LSI) chips used in portable devices, power consumption has become a relatively important design factor. When an LSI chip is installed and used in a portable device, power may be consumed during an active and standby state.

For example, in a relatively small terminal such as a personal digital assistant (PDA), a core LSI chip may constantly be in an active state when a user inputs data into the terminal or executes an application program. However, when there is no input for a given time period or an application program is not being executed, the LSI chip enters a standby state. In a standby state, only internal data necessary to avoid errors and/or faults in a next operation request is maintained.

Conventionally, in the standby state, a clock required for LSI chip operation is cut-off or interrupted and only power supply voltage VDD is applied. As a result, hardware or software is designed to maintain the inner state of the LSI chip and main information until the LSI chip returns to the active state, even when no clock is supplied.

In this example, a time for which the device is in a standby state may be longer than a time for which the device is in the active state. Thus, in a portable device, reducing power consumption in the standby state may be relatively important. Consequently, an LSI chip is designed to provide various standby modes and suppress current in the standby state.

Conventionally, an LSI chip for portable devices is implemented using static logic to more easily maintain data in the standby state. When an LSI chip is designed using static logic, current consumption in the standby state may result from leakage currents between a power supply voltage and a ground voltage and between PN junctions. To reduce the power consumption of the LSI chip and simultaneously improve performance miniaturization technology has been used. With the miniaturization (or size reduction) of a device, LSI chip performance may be improved because a metal oxide semiconductor (MOS) transistor has a shorter channel and capacitance is reduced. Reduction in driving voltage enables lower power consumption.

When device size is reduced, however, operating speed decreases due to a relative increase in threshold voltage of a transistor. To increase operating speed, the threshold voltage of the transistor may be lowered, but when the threshold voltage of the transistor is lowered, the transistor may not be completely turned off in an off state and leakage current may flow.

Conventionally, a multi-threshold complementary MOS (MTCMOS) method may be used to maintain operating speed while reducing device size.

FIG. 1 is a circuit diagram of a conventional semiconductor integrated circuit. The conventional semiconductor integrated circuit of FIG. 1 employs the MTCMOS method, which includes transistors having a relatively low threshold voltage (hereinafter low threshold voltage) and transistors having a relatively high threshold voltage (hereinafter high threshold voltage). All transistors P1 to P4 and N1 to N4 constituting the logic circuit 10 are MOS transistors having a low threshold voltage. A p-channel MOS (PMOS) transistor PM1 and an n-channel MOS (NMOS) transistor NM1 are active transistors having a higher threshold voltage than the transistors of the logic circuit 10.

In this example, one terminal of the NMOS transistor NM1 is connected to a ground voltage VSS, the other terminal is connected to a second node Node2, and the gate terminal is connected to an active signal ACT. One terminal of the PMOS transistor PM1 is connected to a power supply voltage VDD, the other terminal is connected to a first node Node1, and the gate terminal is connected to an inverted active signal ACTB. The logic circuit 10 including the transistors P1 to P4 and N1 to N4 having a low threshold voltage is formed between the first and second nodes Node1 and Node2.

When the active signal ACT is applied at a high logic level (hereinafter high level) in an active state of the MTCMOS circuit, the PMOS transistor PM1 and NMOS transistor NM1 having a high threshold voltage may be turned on. The first and second nodes Node1 and Node2 each operate as a virtual power supply voltage V-VDD and a virtual ground voltage V-VSS, thus decreasing circuit resistance.

On the other hand, when the active signal ACT is applied at a low logic level (hereinafter low level) in a standby state, the PMOS transistor PM1 and the NMOS transistor NM1 may be turned off, and the first and second nodes Node1 and Node2 are floated, thus suppressing leakage current.

In this example, the MTCMOS circuit includes the active transistors PM1 and NM1 having a high threshold voltage. The active transistors PM1 and NM1 may be turned on to make the current flow before the logic circuit 10 enters an active state. When the logic circuit 10 enters a standby state, the active transistors PM1 and NM1 may be turned off, thereby suppressing leakage current.

In another conventional MTCMOS circuit, unlike the circuit in FIG. 1, all the PMOS transistors P1 to P4 of the logic circuit 10 may be connected to the first node Node1, and all the NMOS transistors N1 to N4 may be connected to the second node Node2. However, in this example, the first and second nodes Node1 and Node2 may be floated in a standby state, and data is not maintained. As shown in FIG. 1, a given number of NMOS transistors N1 and N3 may be connected to the ground voltage VSS, and the other NMOS transistors N2 and N4 may be connected to the second node Node2. Likewise, a given number of PMOS transistors P2 and P4 may be connected to the power supply voltage VDD, and the other PMOS transistors P1 and P3 may be connected to the first node Node1. Because the state of an input signal INPUT input in the standby state has been determined (e.g., previously), an MTCMOS circuit is configured as illustrated in FIG. 1, thereby maintaining data using the transistors P2, P4, N1 and N3 to which the voltages are applied even in the standby state.

In the MTCMOS circuit of FIG. 1, the power supply voltage VDD and the ground voltage VSS may be applied to the logic circuit 10 through the NMOS transistor NM1 and the PMOS transistor PM1 during an active operation. Thus, reducing the size of the NMOS transistor NM1 and the PMOS transistor PM1 may be more difficult. In addition, suppressing and/or preventing leakage current using only threshold voltages Vth of the NMOS transistor NM1 and the PMOS transistor PM1 in the standby state may be more difficult. Further, a relatively small leakage current may flow through the transistors P2, P4, N1 and N3 to which the voltages are applied in the standby state.

### SUMMARY

Example embodiments relate to semiconductor integrated circuits, for example, semiconductor integrated circuits having reduced power consumption.

At least one example embodiment provides a semiconductor integrated circuit capable of suppressing and/or preventing leakage current during a standby operation.

In at least one example embodiment, a semiconductor integrated circuit may include a logic circuit, a plurality of switching devices and an equalizer transistor. The logic circuit may include a first circuit and a second circuit. The first circuit may be connected between a power supply voltage and a ground voltage supply line, and the second circuit may be connected between a power supply voltage supply line and a ground voltage. A first of the plurality of switching devices may be connected between the power supply voltage and the power supply voltage supply line, and a second of the plurality of switching devices may be connected between the ground voltage and the ground voltage supply line. The plurality of switching devices may apply the power supply voltage and the ground voltage to the power supply voltage supply line and the ground voltage supply line during an active operation. The equalizer transistor may be connected between the power supply voltage supply line and the ground voltage supply line, and may adjust voltages of the power supply voltage supply line and the ground voltage supply line to be the same or substantially the same during a standby operation.

According to at least some example embodiments, the first circuit may include at least one first n-channel metal-oxide semiconductor (NMOS) transistor and at least one first p-channel metal-oxide semiconductor (PMOS) transistor. The at least one first NMOS transistor may be connected to the ground voltage supply line, and may be configured to receive the ground voltage during an active operation. The at least one first PMOS transistor may be connected between the first NMOS transistor and the power supply voltage. The second circuit may include at least one second PMOS transistor and at least one second NMOS transistor. The at least one second PMOS transistor may be connected to the power supply voltage supply line receiving the power supply voltage during an active operation. The at least one second NMOS transistor may be connected between the second PMOS transistor and the ground voltage.

According to at least some example embodiments, the plurality of switching devices may include at least a PMOS transistor and an NMOS transistor. The PMOS transistor may be connected between the power supply voltage and the power supply voltage supply line. The PMOS transistor may apply the power supply voltage to the power supply voltage supply line in response to an inverted active signal. The NMOS transistor may be connected between the ground voltage and the ground voltage supply line, and may apply the ground voltage to the ground voltage supply line in response to an active signal. The plurality of switching devices may be MOS transistors having a higher threshold voltage than transistors of the circuit.

According to at least some example embodiments, the equalizer transistor may be an NMOS transistor connected between the power supply voltage supply line and the ground voltage supply line and connecting the power supply voltage supply line with the ground voltage supply line in response to an inverted active signal during a standby operation.

At least one other example embodiment provides a semiconductor integrated circuit. According to at least this example embodiment, the semiconductor integrated circuit may include a logic circuit, a first switching device, a second switching device and an equalizer. The logic circuit may be connected between a power supply voltage line and a ground voltage supply line. The first switching device may be connected between a power supply voltage and the power supply voltage supply line. The first switching device may be configured to selectively apply the power supply voltage to the power supply voltage supply line based on a first activation signal. The second switching device may be connected between a ground voltage and the ground voltage supply line. The second switching device may be configured to selectively apply the ground voltage to the ground voltage supply line based on a second activation signal. The equalizer may be connected between the power supply voltage supply line and the ground voltage supply line, and may be configured to adjust voltages of the power supply voltage supply line and the ground voltage supply line such that the voltage of the power supply voltage supply line and the ground voltage supply line are equal.

According to at least some example embodiments, the first and second switching devices may be transistors or transistor circuits. The transistors of the first and second switching devices may be MOS transistors. The transistors of at least one of the first and second switching devices may have a higher threshold voltage than the logic circuit. The first switching device may be a PMOS transistor configured to apply the power supply voltage to the power supply voltage supply line in response to an inverted active signal. The second switching device may be an NMOS transistor configured to apply the ground voltage to the ground voltage supply line in response to an active signal.

According to at least some example embodiments, the logic circuit may include a first circuit connected between the power supply voltage and a ground voltage supply line, and a second circuit connected between a power supply voltage supply line and the ground voltage. The first circuit may include at least one first (NMOS) transistor and at least one second (PMOS) transistor. The at least one first transistor may be connected to the ground voltage supply line and configured to selectively receive the ground voltage during an active operation. The at least one second transistor may be connected between the at least one first transistor and the power supply voltage. The second circuit may include at least one third transistor and at least one fourth transistor. The at least one third transistor being connected to the power supply voltage supply line, and be configured to selectively receive the power supply voltage during an active operation. The at least one fourth transistor may be connected between the second transistor and the ground voltage.

According to at least some example embodiments, the equalizer may include an equalizing transistor configured to connect the power supply voltage supply line with the ground voltage supply line in response to an inverted active signal during a standby operation. The equalizing transistor may be an NMOS transistor.

### BRIEF DESCRIPTION OF THE DRAWINGS

The present invention will be apparent from the more particular description of example embodiments, as illustrated in the accompanying drawings. The drawings are not necessarily to scale, emphasis instead being placed upon illustrating the example embodiments shown therein.

FIG. 1 is a circuit diagram of a conventional semiconductor integrated circuit;

FIG. 2 is a circuit diagram of a semiconductor integrated circuit according to an example embodiment; and

FIGS. 3A and 3B illustrate example simulation results of the semiconductor integrated circuits shown in FIGS. 1 and 2, respectively.

### DETAILED DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Semiconductor integrated circuits capable of suppressing and/or preventing leakage current will now be described more fully hereinafter with reference to the accompanying drawings, in which example embodiments are shown.

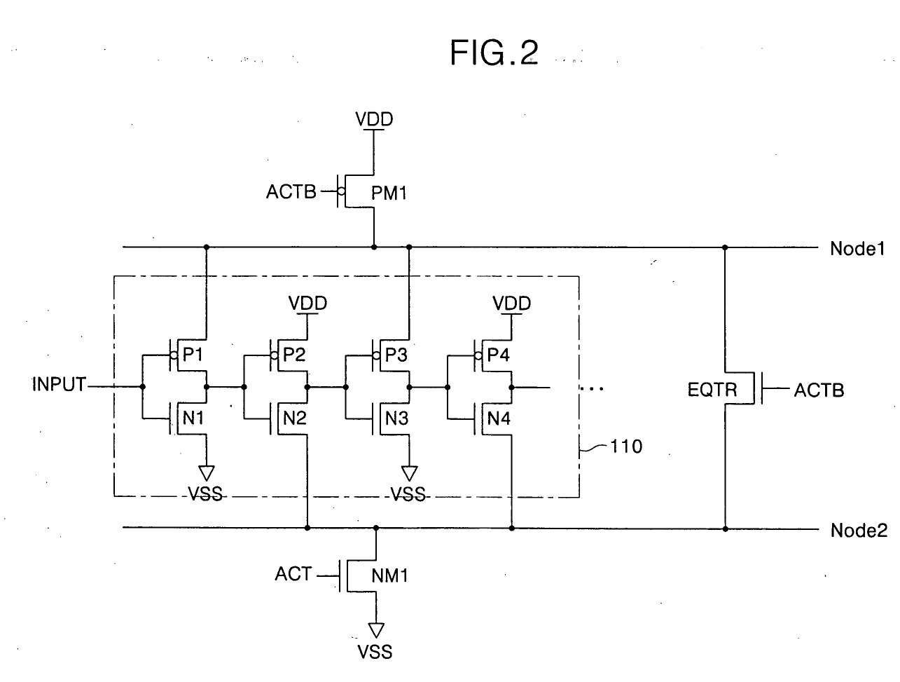

FIG. 2 is a circuit diagram of a semiconductor integrated circuit according to an example embodiment.

Referring to FIG. 2, a semiconductor integrated circuit may include a logic circuit 110, a plurality of switching devices PM1 and NM1 and an equalizer EQTR. The plurality of switching devices PM1 and NM1 may be transistors or transistor circuits, for example, including one or more MOS transistors. According to at least one example embodiment, the switching device PM1 may be a PMOS transistor and the switching device NM1 may be an NMOS transistor. The logic circuit 110 may be connected between a first node or power supply voltage line Node1 and a second node or ground supply voltage line Node2 and may perform a given, desired or predetermined function.

The switching device PM1 may be connected between a power supply voltage VDD and the first node Node1. The switching device NM1 may be connected between a ground voltage VSS and the second node Node2. The switching devices PM1 and NM1 may selectively supply current to the logic circuit 110 based on a state of operation and/or active signals. For example, the switching devices PM1 and NM1 may suppress (e.g., cut-off or interrupt) current supplied to the logic circuit 110 during a standby operation (e.g., while in a standby state) of the semiconductor integrated circuit, and supply the current to the logic circuit 110 during an active operation (e.g., while in an active state). The equalizer EQTR may be connected between the first and second nodes Node1 and Node2, and may adjust voltages of the first and second nodes Node1 and Node2 to be the same or substantially the same (e.g., identical) during the standby operation. For example, the equalizer EQTR may equalize the voltages of the first and second nodes Node1 and Node2.

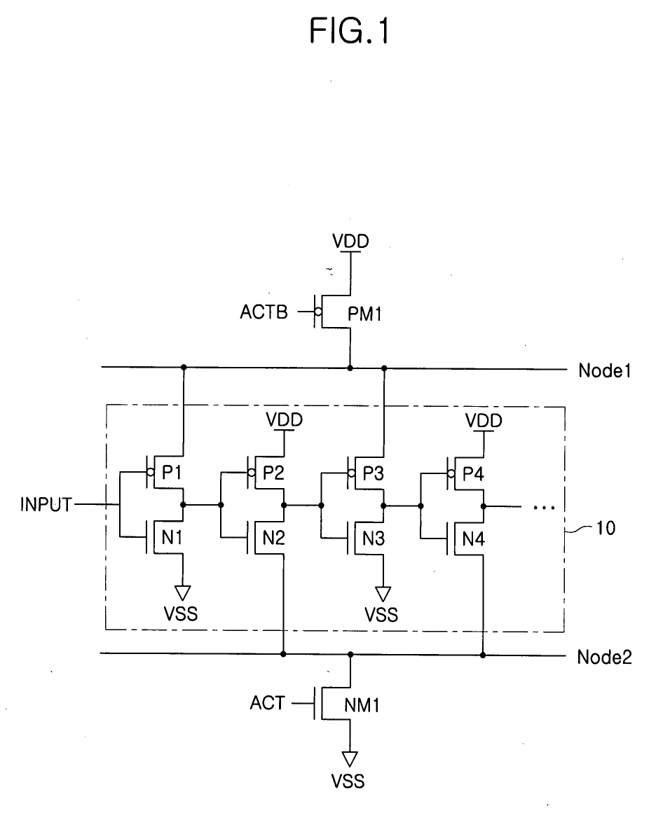

The logic circuit 110 may be a circuit for performing given, desired or predetermined functions specified (e.g., in advance) for its design in the same or substantially the same way as the circuit 10 of FIG. 1. The logic circuit 110 may include a plurality of transistors or transistor circuits. For example, the logic circuit 110 may include a plurality of MOS transistors P1 to P4 and N1 to N4 having relatively low threshold voltages. As shown in FIG. 2, for example, the logic circuit 110 may include a plurality of p-channel MOS (PMOS) transistors P1 to P4 and a plurality of n-channel MOS (NMOS) transistors N1 to N4. The p-channel MOS (PMOS) transistors P1 to P4 and the n-channel MOS (NMOS) transistors N1 to N4 may have different threshold voltages (e.g., low or relatively low threshold voltages), which may be absolute values regardless of a polarity. The PMOS transistors P1 to P4 have a first threshold voltage as the relatively low threshold voltage, and the NMOS transistors N1 to N4 have a second threshold voltage as the relatively low threshold voltage.

In one example, the transistors of logic circuit 110 may be arranged or configured as a plurality of inverters. To maintain data using the MOS transistors P2, P4, N1 and N3 to which voltages are applied in a standby state, a given, desired or predetermined number of NMOS transistors N1 and N3 may be connected to the ground voltage VSS, and the other NMOS transistors N2 and N4 may be connected to the second node Node2. In the same manner, a given, desired or predetermined number of PMOS transistors P2 and P4 may be connected to the power supply voltage VDD, and the other PMOS transistors P1 and P3 may be connected to the first node Node1.

As discussed above, the switching devices PM1 and NM1 may be MOS transistors. In this example, the transistors PM1 and NM1 may have higher threshold voltages than the MOS transistors P1 to P4 and N1 to N4 of the logic circuit 110. Switching device PM1 may be connected between the power supply voltage VDD and the first node Node1. The gate of the switching device PM1 may be configured to receive an inverted active signal ACTB. Switching device NM1 may be connected between the ground voltage VSS and the second node Node2. The switching device NM1 may have a gate to which an active signal ACT is applied.

The switching devices PM1 and NM1 may have a higher or relatively high threshold voltage so as to suppress (e.g., cut-off or interrupt) the current supplied to the logic circuit 110 during a standby operation, and may be larger in size so as to supply a sufficient current to the logic circuit 110 during an active operation. When the logic circuit 110 has a relatively large number of transistors (e.g., MOS transistors) to be driven, a plurality of switching devices (e.g., greater than or equal than 2) may be used to supply the current.

The equalizer EQTR may be a transistor (e.g., a MOS transistor such as an NMOS transistor) connected between the first and second nodes Node1 and Node2. In this example embodiment, the equalizer EQTR may have a gate to which the inverted active signal ACTB may be applied. When the inverted active signal ACTB is applied at a high logic level, the equalizer EQTR may connect the first node Node1 with the second node Node2 to adjust the voltages of the two nodes to be the same or substantially the same. For example, the equalizer EQTR may equalize the voltages of the first node Node1 and the second node Node2.

Example operation of a semiconductor integrated circuit according to an example embodiment will be described with reference to FIG. 2. When the logic circuit 110 is in an active state (e.g., during an active operation), the active signal ACT may be applied at a high logic level and the inverted active signal ACTB may be applied at a low logic level. Thus, the switching device NM1 to which the high-level active signal ACT is applied and the switching device PM1 to which the low-level inverted active signal ACTB is applied may be turned on. When the switching devices PM1 and NM1 are turned on, the power supply voltage VDD may be applied to the first node Node1 through the switching device PM1, and the ground voltage VSS may be applied to the second node Node2 through the switching device NM1, thereby supplying power to drive the logic circuit 110.

When the power is supplied, the logic circuit 110 may perform a given, desired or predetermined operation. In this example, the equalizer EQTR may be turned off in response to the low-level inverted active signal ACTB.

When the logic circuit 110 transitions to a standby state (e.g., during a standby operation), the active signal ACT may be applied at a low logic level and the inverted active signal ACTB may be applied at a high logic level.

The switching device PM1 having the gate to which the high-level inverted active signal ACTB is applied and the switching device NM1 having the gate to which the low-level active signal ACT is applied may be turned off. The first and second nodes Node1 and Node2 may be floated, and power may not be supplied to the logic circuit 110.

In FIG. 2, the logic circuit 110 is a buffer including a plurality of inverters. When an input signal INPUT is set to be applied at a high logic level during a standby operation, a first inverter including transistor P1 and transistor N1 may output a low-level signal. A second inverter including transistor P2 and transistor N2 may receive the low-level signal from the first inverter and output a high-level signal. A third inverter including transistor P3 and transistor N3 and a fourth inverter including transistor P4 and transistor N4 may operate in the same or substantially the same manner. However, the above-described example operation of the logic circuit 110 is not for performing a specific process, but for storing the state of data applied to the buffer using the transistors P2, P4, N1 and N3 that may not be connected to the first and second nodes Node1 and Node2 and receive voltages even during a standby operation.

During a standby operation, the equalizer EQTR may receive a high-level inverted active signal ACTB and turn on. When the equalizer EQTR turns on, the first and second nodes Node1 and Node2 may be connected and share charge. Thus, the first and second nodes Node1 and Node2 may have a voltage equal to about half of the power supply voltage VDD (e.g., ½*VDD).

When the first and second nodes Node1 and Node2 have the same or substantially the same voltage level of about ½*VDD, a reverse bias voltage as a gate-source voltage Vgs may be applied to each of transistors P1 and P3 connected to the first node Node1 and transistors N2 and N4 connected to the second node Node2 among the transistors P1 to P4 and N1 to N4 of the logic circuit 110, thereby suppressing and/or preventing leakage current.

In FIG. 2, the input signal INPUT may be applied at a high logic level during a standby operation. However, when the input signal INPUT is applied at a low logic level, transistors N2 and N4 may be connected to the ground voltage VSS and transistors N1 and N3 may be connected to the second node Node2. In addition, transistors P1 and P3 may be connected to the power supply voltage VDD and transistors P2 and P4 may be connected to the first node Node1.

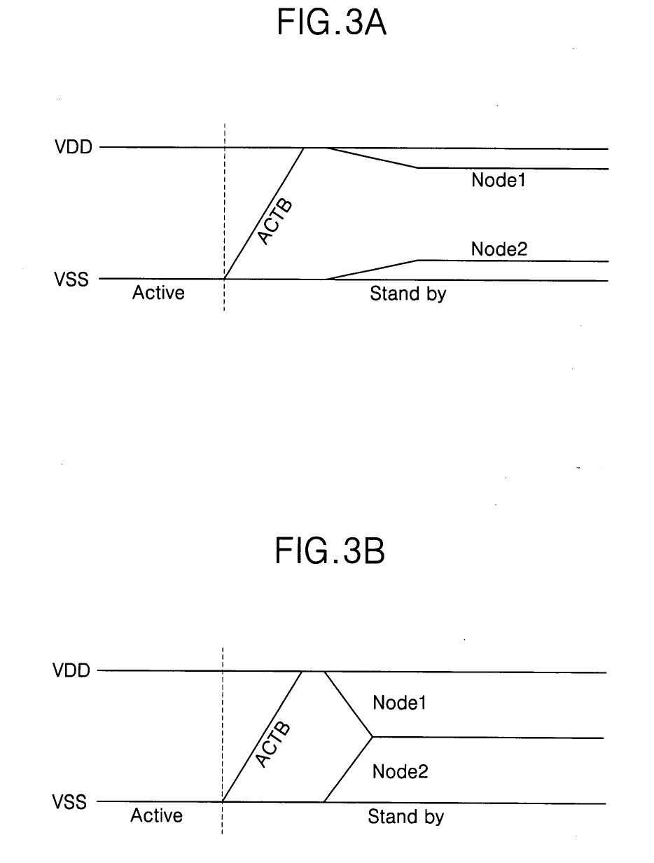

FIGS. 3A and 3B illustrate example simulation results of the semiconductor integrated circuits shown in FIGS. 1 and 2, respectively.

The semiconductor integrated circuit of FIG. 1 will be described with reference to FIGS. 1 and 3A. In an active state, the first node Node1 may receive the power supply voltage VDD through the switching device PM1 and maintains the level of the power supply voltage VDD. The second node Node2 may receive the ground voltage VSS through the switching device NM1 and maintains the level of the ground voltage VSS.

When the conventional semiconductor integrated circuit of FIG. 1 is switched from the active state to the standby state, the active signal ACT changes from a high logic level to a low logic level and the inverted active signal ACTB changes from a low logic level to a high logic level. The active transistors PM1 and NM1 are turned off, and the first and second nodes Node1 and Node2 are floated. Thus, the first node Node1 has a lower voltage level than the power supply voltage VDD by a given, desired or predetermined value, and the second node Node2 has a higher voltage level than the ground voltage VSS by a given, desired or predetermined value.

Referring still to FIGS. 1 and 3A, although the active transistors PM1 and NM1 are turned off, suppressing and/or preventing leakage current using only the threshold voltages Vth thereof may be difficult. Consequently, when the high-level input signal INPUT is applied to the circuit 10 in the conventional semiconductor integrated circuit of FIG. 1, leakage current (e.g., minute leakage currents) may still flow.

The semiconductor integrated circuit of FIG. 2 will be described further with reference to FIGS. 2 and 3B. As described above, in an active state, the first node Node1 may receive the power supply voltage VDD through the switching device PM1 and may maintain the level of the power supply voltage VDD. The second node Node2 may receive the ground voltage VSS through the switching device NM1 and may maintain the level of the ground voltage VSS.

When the semiconductor integrated circuit switches from the active state to the standby state, the active signal ACT may change from a high logic level to a low logic level and the inverted active signal ACTB may change from a low logic level to a high logic level. The switching devices PM1 and NM1 may turn off, and the first and second nodes Node1 and Node2 may be floated.

In this example, the equalizer EQTR may receive the inverted active signal ACTB (e.g., having a high logic level) and may turn on. Thus, the floated first and second nodes Node1 and Node2 may share charge, and have a voltage level equal or substantially equal to a mean or average value of the power supply voltage VDD and the ground voltage VSS.

Consequently, a reverse bias voltage as a gate-source voltage Vgs may be applied to each of the transistors P1 and P3 and the transistors N2 and N4 of the logic circuit 110, thereby suppressing and/or preventing leakage current.

For example, the leakage current may be suppressed and/or prevented by the transistors P1, P3, N2 and N4 of the logic circuit 110 and the threshold voltages Vth of the switching devices PM1 and NM1. Thus, it may be possible to more completely suppress and/or prevent the leakage current.

Although example embodiments have been described herein with regard to a particular arrangement of NMOS and PMOS transistors, it will be understood that these types of transistors may be interchangeable. In addition, any alternative type of switching device and/or transistor may be used in the alternative.

As described above, semiconductor integrated circuits according to example embodiments may include an equalizer connected between first and second nodes using multi-threshold complementary MOS (MTCMOS) technology to apply a reverse bias voltage as a gate-source voltage Vgs of transistors connected to the first and second nodes. Therefore, the transistors of a logic circuit as well as switching devices may suppress and/or prevent leakage current.

Example embodiments have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A semiconductor integrated circuit, comprising:
a logic circuit connected between a power supply voltage line and a ground voltage supply line;
a first switching device connected between a power supply voltage and the power supply voltage supply line, the first switching device being configured to selectively apply the power supply voltage to the power supply voltage supply line based on a first activation signal;
a second switching device connected between a ground voltage and the ground voltage supply line, the second switching device being configured to selectively apply the ground voltage to the ground voltage supply line based on a second activation signal; and
an equalizer connected between the power supply voltage supply line and the ground voltage supply line, the equalizer being configured to adjust voltages of the power supply voltage supply line and the ground voltage supply line such that the voltage of the power supply voltage supply line and the ground voltage supply line are equal.

2. The semiconductor integrated circuit of claim 1, wherein the first and second switching devices are transistors or transistor circuits.

3. The semiconductor integrated circuit according to claim 2, wherein the transistors of the first and second switching devices are MOS transistors.

4. The semiconductor integrated circuit according to claim 2, wherein the first switching device is a PMOS transistor configured to selectively apply the power supply voltage to the power supply voltage supply line in response to an inverted active signal.

5. The semiconductor integrated circuit of claim 2, wherein the second switching device is an NMOS transistor configured to selectively apply the ground voltage to the ground voltage supply line in response to an active signal.

6. The semiconductor integrated circuit according to claim 2, wherein the first switching device is a PMOS transistor configured to selectively apply the power supply voltage to the power supply voltage supply line in response to an inverted active signal, and the second switching device is an NMOS transistor configured to selectively apply the ground voltage to the ground voltage supply line in response to an active signal.

7. The semiconductor integrated circuit according to claim 1, wherein the logic circuit includes,
a first circuit connected between the power supply voltage and a ground voltage supply line, the first circuit being configured to selectively receive the ground voltage during an active operation, and
a second circuit connected between a power supply voltage supply line and the ground voltage, the second circuit being configured to selectively receive the power supply voltage during an active operation.

8. The semiconductor integrated circuit according to claim 7, wherein the equalizer includes an equalizing transistor configured to connect the power supply voltage supply line with the ground voltage supply line in response to an inverted active signal during a standby operation.

9. The semiconductor circuit according to claim 7, wherein the first circuit includes,
at least one first transistor and at least one second transistor, the at least one first transistor being connected to the ground voltage supply line and configured to selectively receive the ground voltage during an active operation, the at least one second transistor being connected between the at least one first transistor and the power supply voltage.

10. The semiconductor integrated circuit according to claim 9, wherein the first and second switching devices each include a transistor having a higher threshold voltage than the at least one first transistor and at least one second transistor.

11. The semiconductor circuit according to claim 9, wherein the at least one first transistor is an NMOS transistor and the at least one second transistor is a PMOS transistor.

12. The semiconductor circuit according to claim 9, wherein the second circuit includes,
at least one third transistor and at least one fourth transistor, the at least one third transistor being connected to the power supply voltage supply line, and being configured to selectively receive the power supply voltage during an active operation, the at least one fourth transistor being connected between the third transistor and the ground voltage.

13. The semiconductor circuit according to claim 7, wherein the second circuit includes,
at least one third transistor and at least one fourth transistor, the at least one third transistor being connected to the power supply voltage supply line, and being configured to selectively receive the power supply voltage during an active operation, the at least one fourth transistor being connected between the third transistor and the ground voltage.

14. The semiconductor integrated circuit according to claim 13, wherein the first and second switching devices each include a transistor having a higher threshold voltage than the at least one third transistor and at least one fourth transistor.

15. The semiconductor circuit according to claim 13, wherein the at least one third transistor is a PMOS transistor and the at least one fourth transistor is an NMOS transistor.

16. The semiconductor integrated circuit according to claim 1, wherein the equalizer includes an equalizing transistor configured to connect the power supply voltage supply line with the ground voltage supply line in response to an inverted active signal during a standby operation.

17. The semiconductor integrated circuit according to claim 16, wherein the equalizing transistor is an NMOS transistor.

18. The semiconductor integrated circuit according to claim 1, wherein each of the logic circuit, the first switching device, the second switching device and the equalizer are comprised of at least one transistor or transistor circuit.

19. The semiconductor integrated circuit according to claim 18, wherein at least one of the logic circuit, the first switching device, the second switching device and the equalizer is comprised of at least one transistor.

20. The semiconductor integrated circuit according to claim 19, wherein the at least one transistor is a MOS transistor.
